(19) United States
(12) Patent Application Publication
(10) Pub. No.: US 2023/0252813 A1
(43) Pub. Date: Aug. 10, 2023

(54) IMAGE READING DEVICE

(71) Applicant: TOSHIBA TEC KABUSHIKI KAISHA, Tokyo (JP)

(72) Inventor: Kiyoshi Iwaki, Mishima Shizuoka (JP)

(21) Appl. No.: 17/668,405

(22) Filed: Feb. 10, 2022

(51) Int. Cl. G06V 30/418; G06V 30/412; H04N 1/00; G06V 30/19; G06V 30/14

(52) U.S. Cl. CPC G06V 30/418; G06V 30/412; H04N 1/00331; G06V 30/1908; G06V 30/1456; G06V 30/1448; H04N 1/00045; H04N 1/00408; H04N 2201/0081

(57) ABSTRACT

According to one embodiment, an image reading device includes an image reading unit, a control unit, and an output unit. The image reading unit reads an image formed on a document to generate read image data. The control unit extracts at least one predetermined area from the read image data to generate extracted image data, compares the extracted image data and reference image data determined for each of the predetermined area, for each of the predetermined area, and generates an aggregated image obtained by aggregating the extracted image data and information indicating a result of the comparison. The output unit outputs the aggregated image.

### FIELD

Embodiments described herein relate generally to an image reading device and methods related thereto.

### BACKGROUND

In the related art, for example, there is a technique for assisting the user in confirming whether necessary information is correctly described in a standard format document such as a form or an application form. As such a technique in the related art, for example, there is a technique for facilitating confirmation of the contents of a document by displaying image data of a document of a plurality of pages read by a scanner as a thumbnail image.

However, in the technique in the related art, if the positions of items that need to be confirmed are dispersed in the page or spread in a plurality of pages, an item to be confirmed by the user may be overlooked, and the confirmation thereof may be omitted.

### DESCRIPTION OF THE DRAWINGS

FIG. 1 is an external view illustrating an overall configuration example of an image forming apparatus 100;

FIG. 2 is a schematic view illustrating a portion of a configuration example of an image reading unit 200;

FIG. 3 is a block diagram illustrating a hardware configuration of the image forming apparatus 100;

FIG. 4 is a block diagram illustrating a functional configuration of a control unit 101;

FIG. 5 is a block diagram illustrating a configuration of an auxiliary storage device 103;

FIG. 6 is a diagram illustrating an example of a reference document and an extraction range setting;

FIG. 7 is a diagram illustrating another example of the extracted area setting;

FIG. 8 is a diagram illustrating an example of a read document;

FIG. 9 is a diagram illustrating an example of an aggregated image;

FIG. 10 is a flowchart illustrating an operation of the image forming device 100 if a reference document image is acquired;

FIG. 11 is a flowchart illustrating an operation of the image forming device 100 if a read document image is acquired;

FIG. 12 is a diagram illustrating an example of an aggregated image;

FIG. 13 is a block diagram illustrating a functional configuration of a control unit 101-1;

FIG. 14 is a block diagram illustrating a configuration of an auxiliary storage device 103-1;

FIG. 15 is a diagram illustrating an example of the aggregated image;

FIG. 16 is a diagram illustrating an example of the aggregated image;

FIG. 17 is a diagram illustrating an example of the aggregated image; and

FIG. 18 is a diagram illustrating an example of the aggregated image.

### DETAILED DESCRIPTION

The problem to be solved by the embodiments is to provide an image reading device capable of facilitating the confirmation work of the information described in the document and reducing the occurrence of confirmation omission by the user.

In general, according to one embodiment, an image reading device includes an image reading unit, a control unit, and an output unit. The image reading unit reads an image formed on a document to generate read image data. The control unit extracts at least one predetermined area from the read image data to generate extracted image data, compares the extracted image data and reference image data determined for each of the predetermined area, for each of the predetermined area, and generates image data indicating an aggregated image obtained by aggregating the extracted image data and information indicating a result of the comparison. The output unit outputs the aggregated image.

Hereinafter, an image reading device of an embodiment is described with reference to the drawings.

### First Embodiment

Hereinafter, an image forming device 100 of a first embodiment is described. The image forming device 100 according to the first embodiment reads a document, for example, in a standard format such as a business form or an application form and generates image data indicating the read image. Hereinafter, a document to be read is referred to as a “read document”. Hereinafter, the image obtained by reading the read document is referred to as a “read document image”.

The image forming device 100 specifies whether information is entered in a predetermined entry field of the read document. For example, the predetermined entry field is an entry field of an item that is required to be entered in a business form or an application form. Specifically, the image forming device 100 extracts image data indicating an image of an area including a predetermined entry from image data indicating the read document image. Hereinafter, an area including a predetermined entry field in a document is referred to as an “extracted area”. Hereinafter, an image of an extracted area that is extracted from a read document image is referred to as an “extracted image”.

The image forming device 100 acquires image data indicating an image of a sample document to be a reference in advance. Hereinafter, the sample document to be the reference is referred to as a “reference document”. The reference document is a blank business form or a blank application form in which nothing is entered. Hereinafter, an image indicating the reference document is referred to as a “reference document image”.

The image forming device 100 specifies whether information is entered in a predetermined entry field of a read document, based on the reference document image. Specifically, the image forming device 100 extracts image data indicating the image of the extracted area from image data indicating the reference document image. Hereinafter, an image of the extracted area that is extracted from the reference document image is referred to as a “reference image”.

The image forming device 100 specifies whether information is entered in a predetermined entry field of the read document by comparing the extracted image and the reference image. The extracted image and the reference image compared herein are images of the same extracted area.

Specifically, if the extracted image and the reference image are the same images, the image forming device 100 determines that the information is entered in a predetermined entry field of the read document. This is because, if the information is not entered in an entry field of the read document, a state of the entry field is not changed from the entry field of the reference document. In contrary, if the extracted image and the reference image are different images, the image forming device 100 determines that the information is entered in the predetermined entry field of the read document.

The image forming device 100 compares the extracted image and the reference image on a per extracted area basis. The image forming device 100 generates image data indicating an image obtained by aggregating the extracted images that are extracted from one read document. Hereinafter, the image obtained by aggregating the extracted images is referred to as an “aggregated image”.

At this point, the image forming device 100 generates image data indicating the aggregated image that can distinguish an extracted image that is determined that information is not entered in an entry field and an extracted image that is determined that information is entered in an entry field. For example, the image forming device 100 generates image data indicating an aggregated image so that the circumference of the extracted image that is determined that the information is not entered in the entry field is noticeably surrounded by a thick frame.

By being provided with such a configuration, the image forming device 100 can promote, to a user, an aggregated image that is obtained by aggregating an area of a predetermined entry field from the read document and enables an unfilled entry field to be grasped at a glance. Accordingly, the image forming device 100 can more simplify the work of the user for confirming whether the information is entered in the predetermined entry field.

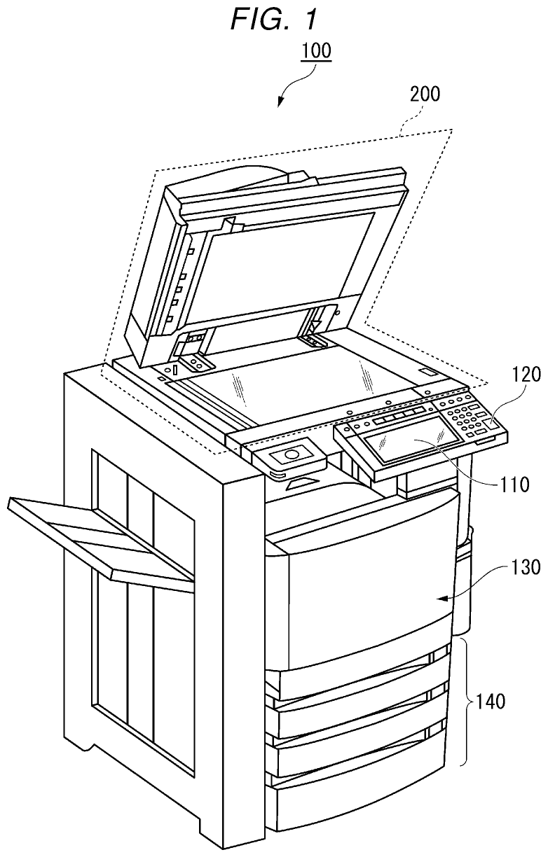

Hereinafter, the configuration of the image forming device 100 according to the first embodiment is described more specifically. FIG. 1 is an external view illustrating an overall configuration example of the image forming device 100. The image forming device 100 according to the present embodiment is a multifunction peripheral (MFP). The image forming device 100 is an example of the image reading device and may be, for example, a copier or a scanner, instead of the multifunction peripheral.

The image forming device 100 includes a display 110, a control panel 120, a printer unit 130, a sheet containing unit 140, and an image reading unit 200.

The display 110 (display unit) is a display device such as a liquid crystal display (LCD) or electro luminescence (EL) display. The display 110 displays various kinds of information relating to the image forming device 100 under the control by a control unit 101 below. In addition, the display 110 may be, for example, an input and output device such as a touch panel that is integrated with the control panel 120 described below.

The control panel 120 is an input device that receives an input operation of the user. The control panel 120 includes, for example, a plurality of input buttons. In addition, if the control panel 120 is, for example, a touch panel integrated with the display 110, the input buttons may be images displayed on the display 110. The control panel 120 outputs an operation signal according to the input operation of the user to the control unit 101.

The printer unit 130 forms an image on a sheet based on an image data file including the image data generated by the image reading unit 200. The printer unit 130 may be a device that form an image by fixing a visible image such as a toner image on a sheet to or may be a device that forms an image by an inkjet method. The sheet is, for example, paper or label paper. However, the sheet may be any material as long as the image forming device 100 can form an image on the surface thereof. The sheet may be a sheet contained in the sheet containing unit 140 or may be a sheet manually inserted into the image forming device 100.

The sheet containing unit 140 contains a sheet used for forming an image by the printer unit 130.

The image reading unit 200 reads an image formed on a document mounted on a document table based on based on brightness and darkness of light and generates image data that is digital data. The image reading unit 200 outputs the generated image data to the control unit 101. The control unit 101 stores an image data file including the input image data in the auxiliary storage device 103 described below. The control unit 101 may output the image data file to an external storage device or an external storage medium, for example, via a network. The control unit 101 may output the image data file to the printer unit 130 as it is, without storing the image data file in the storage device or the like.

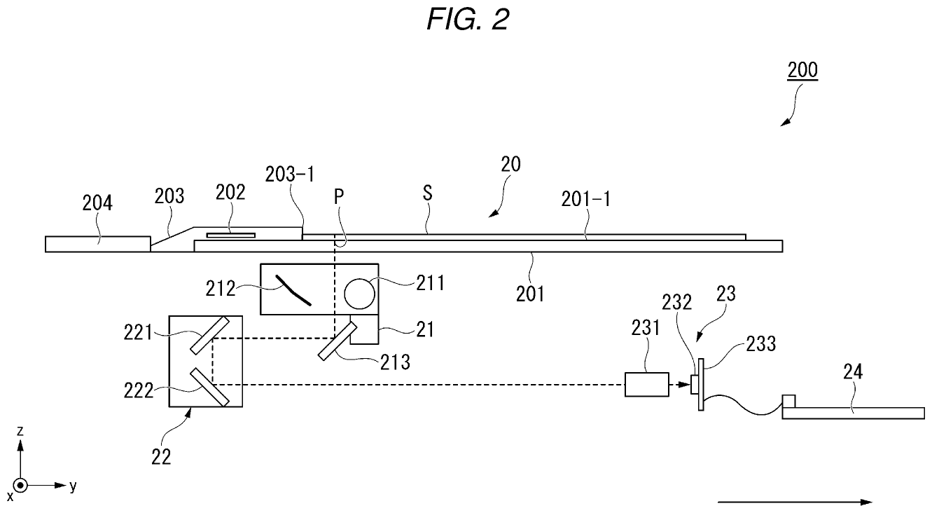

Subsequently, the configuration of the image reading unit 200 of the image forming device 100 according to the first embodiment is more specifically described with reference to FIG. 2. FIG. 2 is a schematic view illustrating a portion of the configuration example of the image reading unit 200.

The image reading unit 200 includes a document table 20, a first carriage 21, a second carriage 22, an image capturing unit 23, and an image reading control unit 24. The direction in which the first carriage 21 moves is a sub-scanning direction y. In the document table 20, the direction orthogonal to the sub-scanning direction y is a main scanning direction x. The direction orthogonal to the main scanning direction x and the sub-scanning direction y is a height direction z.

The document table 20 includes a document table glass 201, a shading plate 202, a document scale 203, and a through lead glass 204.

The document table glass 201 includes a mounting surface 201-1 on which the document is mounted. The shading plate 202 is configured with a white member. The shading plate 202 includes white to be a reference in case of shading correction on the image read from the document. The shading plate 202 has a long shape in the main scanning direction x.

The document scale 203 has a position of the document mounted on the document table glass 201. A tip reference portion 203-1 is provided in an end portion of the document scale 203. The tip reference portion 203-1 forms a convex portion for pressing the end portion of the document by forming a step with the mounting surface 201-1 of the document table glass 201. The position of the document is determined by pressing the document to the document table glass 201 at the tip reference portion 203-1. A position for mounting an angle of the tip of the document is determined on the mounting surface 201-1 in advance. By mounting the angle of the tip of the document at the position determined in advance, the positions of the main scanning direction x and the sub-scanning direction y are determined.

The first carriage 21 includes a light source 211, a reflector 212, and a first mirror 213. The light source 211 emits light. The reflector 212 reflects light emitted from the light source 211. The light reflected by the reflector 212 is uniformly applied to the shading plate 202 and the document. The light distribution characteristic in the main scanning direction x at the reading position of the document is adjusted based on the reflected light of the applied light. The first mirror 213 reflects the light reflected by the shading plate 202 and the document toward a second mirror 221 of the second carriage 22.

The second carriage 22 includes the second mirror 221 and a third mirror 222. The second mirror 221 reflects the light reflected by the first mirror 213 to the third mirror 222. The third mirror 222 reflects the light reflected by the second mirror 221 to a condenser lens 231 of the image capturing unit 23.

The image capturing unit 23 includes the condenser lens 231, a CCD sensor 232, and a CCD substrate 233. The condenser lens 231 condenses the light reflected by the third mirror 222. The condenser lens 231 images the condensed light on an image plane (reading surface) of the CCD sensor 232.

The CCD sensor 232 is provided on the CCD substrate 233. For example, the CCD sensor 232 is a hybrid 4-line sensor. The hybrid 4-line sensor includes a 3-line sensor that reads a color image and a 1-line sensor that reads a monochrome image. The 3-line sensor reads light of R (red), G (green), and B (blue). The CCD sensor 232 converts the light imaged by the condenser lens 231 into electric charges. According to this conversion, the CCD sensor 232 converts the image imaged by the condenser lens 231 into an electric signal.

The CCD substrate 233 generates the image data based on the electric signal generated by photoelectric conversion of the CCD sensor 232. If the image data is generated, the CCD substrate 233 generates the image data by using the correction information obtained by a shading correction treatment in advance. The CCD substrate 233 outputs the generated image data to the image reading control unit 24. The treatment performed by the CCD substrate 233 as described above is performed by Analog Front End (AFE) provided on the CCD substrate 233.

The image reading control unit 24 controls the first carriage 21, the second carriage 22, and the image capturing unit 23. For example, the image reading control unit 24 controls the movement of the first carriage 21 and turning-on and turning-off of the light source 211 of the first carriage 21. For example, the image reading control unit 24 controls operations of the image capturing unit 23.

The first carriage 21 moves in the sub-scanning direction y in response to the control of the image reading control unit 24. The second carriage 22 moves at the speed of ½ in the same direction as the first carriage 21 according to the movement of the first carriage 21. According to this operation, even if the first carriage 21 moves, the optical path length of the light that reaches the image plane of the CCD sensor 232 does not change. That is, the optical path length of the light in the optical system that is configured with the first mirror 213, the second mirror 221, the third mirror 222, and the condenser lens 231 is constant. In other words, the optical path length from the mounting surface 201-1 to the image plane of the CCD sensor 232 is constant.

For example, in the example of FIG. 2, the first carriage 21 moves from the left to the right in the sub-scanning direction y. According to the movement of the sub-scanning direction y of the first carriage 21, a reading position P to the document also moves. Therefore, the reading position P moves from the left to the right in the sub-scanning direction y. The reading position P is a position for one line of the main scanning direction x. The reading position P moves in the sub-scanning direction y so that images of the reading position P of the document are sequentially imaged on the image plane of the CCD sensor 232. The CCD sensor 232 outputs the signal according to the image of the imaged reading position P as a signal for one line of the main scanning direction x. The CCD substrate 233 generates the image data of the entire area on the document table glass 201 based on signals for a plurality of lines.

The image reading unit 200 includes, for example, an auto document feeder (ADF). The ADF feeds each page of the document of a plurality of pages to be read to the document table 20. However, the document of the plurality of pages may be manually fed to the document table 20 sequentially.

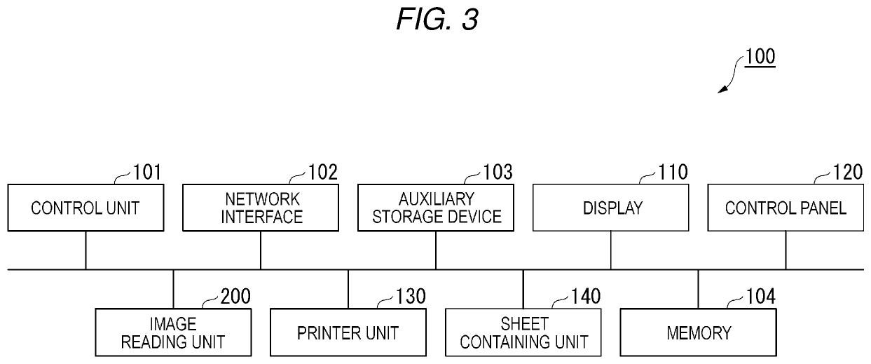

Subsequently, the hardware configuration of the image forming device 100 according to the first embodiment is described with reference to FIG. 3. FIG. 3 is a block diagram illustrating the hardware configuration of the image forming device 100.

The image forming device 100 includes the control unit 101, a network interface 102, an auxiliary storage device 103, a memory 104, the display 110, the control panel 120, the printer unit 130, the sheet containing unit 140, and the image reading unit 200. Components included in the image forming device 100 can be connected to each other via an internal bus and transmit and receive data. A functional unit described with reference to FIG. 1 is denoted by the same reference numeral as in FIG. 1, and the description thereof is omitted.

The control unit 101 controls the operation of each component of the image forming device 100. The control unit 101 executes various kinds of treatments of each component by executing the program. A program is stored, for example, in the memory 104 or the auxiliary storage device 103, in advance. The functional configuration of the control unit 101 is specifically described below.

The network interface 102 transmits and receives data to and from an external device. The network interface 102 operates as an input interface and receives data transmitted from the external device. The network interface 102 operates as an output interface and transmits data to an external device.

The auxiliary storage device 103 is a storage medium such as a hard disk drive (HDD) or a solid state drive (SSD). The auxiliary storage device 103 stores various kinds of data. Examples of the various kinds of data include image data, image data file, and various kinds of setting data. The configuration of the information stored in the auxiliary storage device 103 is described below.

For example, the memory 104 is a storage medium such as a random access memory (RAM). The memory 104 temporarily stores data and a program used by each component included in the image forming device 100. The digital data such as image data generated by the image reading unit 200 may be a configuration stored in the memory 104 instead of the auxiliary storage device 103.

Subsequently, the configuration of the control unit 101 of the image forming device 100 and the configuration of the auxiliary storage device 103 are described.

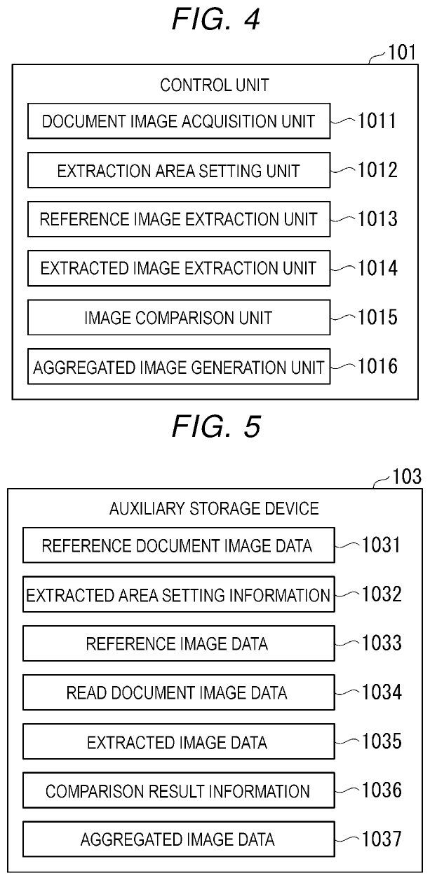

FIG. 4 is a block diagram illustrating the functional configuration of the control unit 101. As illustrated in FIG. 4, the control unit 101 includes a document image acquisition unit 1011, an extracted area setting unit 1012, a reference image extraction unit 1013, an extracted image extraction unit 1014, an image comparison unit 1015, and an aggregated image generation unit 1016.

FIG. 5 is a block diagram illustrating the configuration of the auxiliary storage device 103. As illustrated in FIG. 5, the auxiliary storage device 103 stores reference document image data 1031, extracted area setting information 1032, reference image data 1033, read document image data 1034, extracted image data 1035, comparison result information 1036, and aggregated image data 1037.

The document image acquisition unit 1011 acquires the image data indicating a reference document image. As described above, the reference document image is an image illustrating a reference document. The document image acquisition unit 1011 stores the image data illustrating the acquired reference document image in the auxiliary storage device 103 as the reference document image data 1031.

The image data indicating the reference document image is generated, for example, by reading the image formed in the reference document by the image reading unit 200. In this case, the document image acquisition unit 1011 acquires the image data indicating the reference document image from the image reading unit 200. In addition, the image data indicating the reference document image may be generated, for example, on a PC of a user. In this case, the document image acquisition unit 1011 acquires the image data indicating the reference document image from the corresponding PC via the network interface 102.

The extracted area setting unit 1012 acquires information indicating an extracted area. As described above, the extracted area is an area including a predetermined entry field on the document. The information indicating the extracted area is, for example, a coordinate data of an XY direction indicating the position on the document. The extracted area setting unit 1012 stores the acquired information indicating the extracted area in the auxiliary storage device 103 as the extracted area setting information 1032.

The information indicating the extracted area may be information indicating a relative positional relationship with a mark (for example, an anchor) printed at a predetermined position on the document. For example, the anchor is a predetermined symbol written to the corner of the document, a description of a predetermined title written in an upper portion of the document, or a description of each predetermined item name written next to the entry field.

The extracted area setting unit 1012 acquires the reference document image data 1031, for example, from the auxiliary storage device 103. The extracted area setting unit 1012 displays the reference document image on the display 110 based on the acquired reference document image data 1031. The extracted area setting unit 1012 display an image indicating a rectangular frame for designating an extracted area on the display 110.

The control panel 120 changes the position or the size of the rectangular frame displayed on the display 110 in response to the input operation of the user. The user can change the position or the size of the corresponding rectangular frame by using the control panel 120. Accordingly, the user can set a surrounded area as an extracted area by surrounding at least one desired entry field on the document with a rectangular frame.

The control panel 120 outputs the information indicating the set extracted area to the extracted area setting unit 1012. The extracted area setting unit 1012 acquires the information indicating the extracted area output from the control panel 120.

The extracted area may be set on the PC of the user. In this case, the extracted area setting unit 1012 acquires the information indicating the extracted area from the corresponding PC via the network interface 102.

The reference image extraction unit 1013 acquires the reference document image data 1031 and the extracted area setting information 1032 that are stored in the auxiliary storage device 103. The reference image extraction unit 1013 extracts the image data indicating the reference image based on the acquired reference document image data 1031 and the acquired extracted area setting information 1032. The reference image extraction unit 1013 stores the extracted image data indicating the reference image in the auxiliary storage device 103 as the reference image data 1033.

Specifically, the reference image extraction unit 1013 extracts the image according to coordinates indicated by the extracted area setting information 1032, for example, from the reference document image based on the reference document image data 1031. Accordingly, the reference image extraction unit 1013 acquires the image data indicating the reference image.

The document image acquisition unit 1011 acquires image data indicating a read document image. As described above, the read document image is an image obtained by reading the read document. The document image acquisition unit 1011 stores the acquire image data indicating the read document image in the auxiliary storage device 103 as the read document image data 1034.

The image data indicating the read document image is generated by reading the image formed on the read document by the image reading unit 200. In this case, the document image acquisition unit 1011 acquires the image data indicating the read document image from the image reading unit 200. In addition, the image data indicating the read document image may be generated, for example, by an external image reading device. In this case, the document image acquisition unit 1011 acquires the image data indicating the read document image from external image reading device via the network interface 102.

The extracted image extraction unit 1014 acquires the read document image data 1034 and the extracted area setting information 1032 stored in the auxiliary storage device 103. The extracted image extraction unit 1014 extracts the image data indicating the extracted image based on the acquired read document image data 1034 and the acquired extracted area setting information 1032. The extracted image extraction unit 1014 stores the extracted image data indicating the extracted image in the auxiliary storage device 103 as the extracted image data 1035.

Specifically, the extracted image extraction unit 1014 extracts the image from the read document image, for example, based on the read document image data 1034 according to the coordinates indicated by the extracted area setting information 1032. Accordingly, the extracted image extraction unit 1014 obtains the image data indicating the extracted image.

The image comparison unit 1015 acquires the reference image data 1033 and the extracted image data 1035 stored in the auxiliary storage device 103. The image comparison unit 1015 compares the reference image based on the reference image data 1033 and the extracted image based on the extracted image data 1035 for each extracted area. The image comparison unit 1015 determines whether the reference image and the extracted image are the same based on the comparison result. The image comparison unit 1015 stores the information indicating the comparison result for each extracted area in the auxiliary storage device 103 as the comparison result information 1036.

The image comparison unit 1015 determines whether the reference image and the extracted image are the same, for example, by comparing the luminance value of the reference image and the luminance value of the extracted image for each pixel at the same position. For example, if the average square error between the luminance value of the reference image and the luminance value of the extracted image are less than a predetermined threshold value, the image comparison unit 1015 may determine that the reference image and the extracted image are the same. In addition, the image comparison unit 1015 may determine whether the reference image and the extracted image are the same, for example, by comparing the pixel value instead of the luminance value for each pixel.

The aggregated image generation unit 1016 acquires the extracted image data 1035 and the comparison result information 1036 from the auxiliary storage device 103. The aggregated image generation unit 1016 generates the image data indicating the aggregated image based on the acquired extracted image data 1035 and the acquired comparison result information 1036. As described above, the aggregated image is an image obtained by aggregating extracted images extracted from one read document.

At this point, the aggregated image generation unit 1016 adds the information indicating the comparison result for each extracted area to the aggregated image data based on the comparison result information 1036. Specifically, the aggregated image generation unit 1016 generates the image data indicating the aggregated image, for example, in which the circumference of the extracted image determined to be the same as the reference image is surrounded by a thick frame.

It is assumed that the information is not entered in the entry field included in the corresponding extracted image in the extracted image determined to be the same as the reference image. Therefore, the aggregated image generation unit 1016 generates image data indicating the aggregated image so that the extracted image determined to be the same as the reference image is noticeable. Accordingly, the user can refer to the aggregated image to easily grasp the unfilled entry field due to omission of entry or the like.

The aggregated image generation unit 1016 stores the generated image data indicating the aggregated image in the auxiliary storage device 103 as the aggregated image data 1037. The aggregated image generation unit 1016 may promote the corresponding aggregated image to the user by displaying the aggregated image on the display 110.

Otherwise, the aggregated image generation unit 1016 may promote the corresponding aggregated image to the user, for example, by outputting the image data indicating the aggregated image to the printer unit 130 to form the aggregated image on the sheet. Otherwise, the aggregated image generation unit 1016 transmit, for example, the image data indicating the aggregated image to the PC of the user via the network interface 102. Accordingly, the user can refer to the aggregated image on the PC of the user.

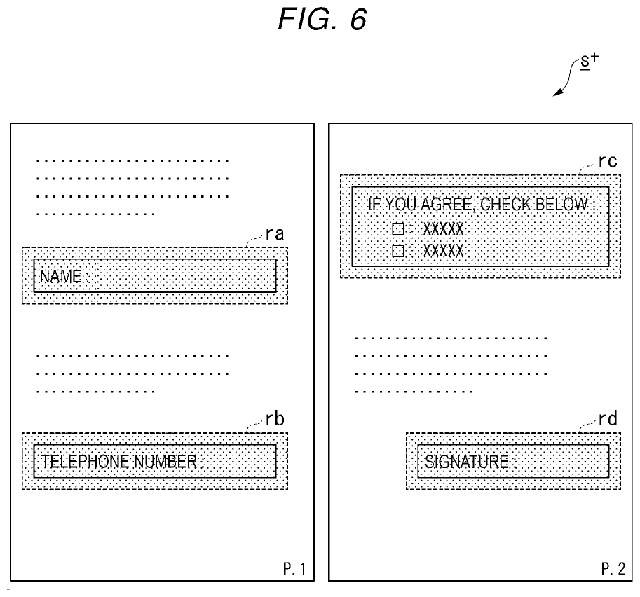

Hereinafter, the generation of the aggregated image by the image forming device 100 according to the first embodiment is described with reference to specific examples. FIG. 6 is a diagram illustrating an example of the reference document and the extracted area setting.

FIG. 6 illustrates a reference document st including two pages. The reference document st is, for example, an application form of a standard format. Two entry fields of a name and a telephone number are provided on the first page of the reference document st. In addition, two entry fields of a consent field and a signature field are provided on the second page of the reference document st.

FIG. 6 illustrates a state in which the user sets all of the four entry fields of the reference document st as the extracted areas. The user performs an input operation of surrounding the four entry fields with rectangles, for example, by using the control panel 120. Accordingly, the coordinates of the extracted areas are designated respectively, and extracted areas ra to rd are respectively set as illustrated in FIG. 6.

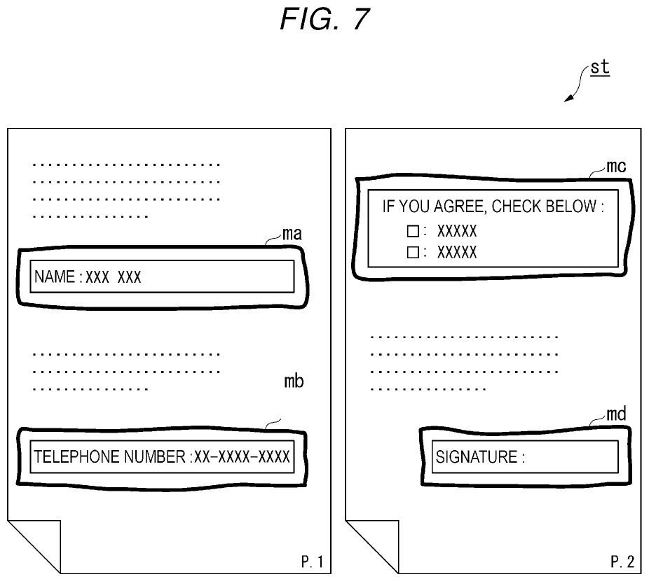

The setting of the extracted area is not limited to a method of surrounding the entry fields on the reference image with rectangles as described above and may be performed, for example, by a following method. FIG. 7 is a diagram illustrating another example of the extracted area setting. FIG. 7 illustrates the reference document st including two pages as in FIG. 6.

FIG. 7 illustrates a state in which the user surrounds the four entry fields included in the actual reference document st, for example, by using a predetermined marker to draw frame lines ma to md of a predetermined color (or a predetermined type of line). The image reading unit 200 reads a reference document in which the frame lines are drawn with the predetermined marker and generates the image data indicating reference document image. The document image acquisition unit 1011 acquires the image data generated by the image reading unit 200 and stores the image data in the auxiliary storage device 103 as the reference document image data 1031.

The extracted area setting unit 1012 acquires the reference document image data 1031 stored in the auxiliary storage device 103. The extracted area setting unit 1012 analyzes the reference document image based on the acquired reference document image data 1031 and specifies portions in which the frame lines ma to md are drawn with the predetermined marker. The extracted area setting unit 1012 sets extracted areas by approximating the frames surrounded by the frame lines ma to md with rectangles, respectively.

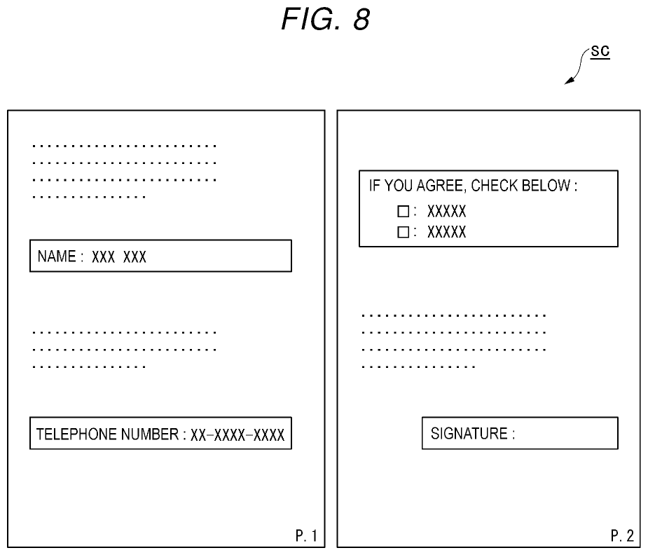

FIG. 8 is a diagram illustrating an example of the read document. A read document sc illustrated in FIG. 8 is a document in which information is entered in the reference document illustrated in FIG. 6. As illustrated in FIG. 8, two entry fields of the name and the telephone number in the read document sc are filled, respectively. In addition, two entry fields of the consent field and the signature field in the read document sc are not filled, and omission of entry occurs.

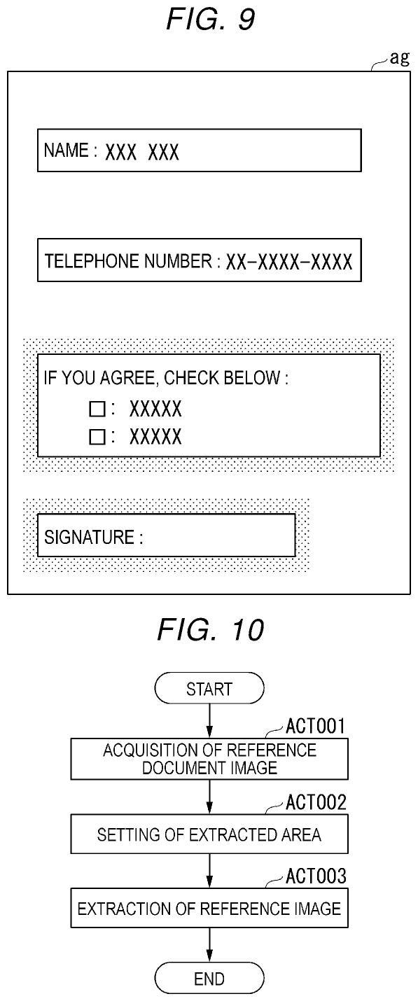

FIG. 9 is a diagram illustrating an example of the aggregated image. An aggregated image ag illustrated in FIG. 9 is an image obtained by aggregating the extracted images extracted from the read document sc illustrated in FIG. 8. As illustrated in FIG. 9, the aggregated image generation unit 1016 generates the image data indicating the aggregated image in which the circumferences of the extracted images including the consent field and the signature field which are the unfilled entry fields are surrounded by thick frames.

Hereinafter, the operation of the image forming device 100 according to the first embodiment is described. First, an example of the operation in case of acquiring the reference document image of the image forming device 100 is described. FIG. 10 is a flowchart illustrating the operation in case of acquiring the reference document image of the image forming device 100 according to the first embodiment. The operation of the image forming device 100 illustrated in the flowchart of FIG. 10 starts, for example, if the image data indicating reference document image is transmitted from the image reading unit 200, the PC of the user, or the like to the control unit 101.

First, the document image acquisition unit 1011 acquires the image data indicating reference document image. The document image acquisition unit 1011 stores the acquired image data indicating reference document image in the auxiliary storage device 103 as the reference document image data 1031 (ACT 001).

Subsequently, the extracted area setting unit 1012 acquires the reference document image data 1031 from the auxiliary storage device 103. The extracted area setting unit 1012 displays the reference document image on the display 110 based on the acquired reference document image data 1031. Also, the extracted area setting unit 1012 displays the image illustrating rectangular frames for designating extracted areas on the display 110. The control panel 120 changes the position or the size of the rectangular frames displayed on the display 110 in response to the input operation of the user. The control panel 120 outputs the information indicating the set extracted area to the extracted area setting unit 1012. The extracted area setting unit 1012 acquires the information indicating the extracted area output from the control panel 120. The extracted area setting unit 1012 stores the acquired information indicating the extracted area in the auxiliary storage device 103 as the extracted area setting information 1032 (ACT 002).

Subsequently, the reference image extraction unit 1013 acquires the reference document image data 1031 and the extracted area setting information 1032 stored in the auxiliary storage device 103. The reference image extraction unit 1013 extracts the image data indicating the reference image based on the acquired reference document image data 1031 and the acquired extracted area setting information 1032. The reference image extraction unit 1013 stores the extracted image data indicating the reference image in the auxiliary storage device 103 as the reference image data 1033 (ACT 003).

In the above, the operation in case of acquiring the reference document image of the image forming device 100 which is illustrated in the flowchart of FIG. 10 ends.

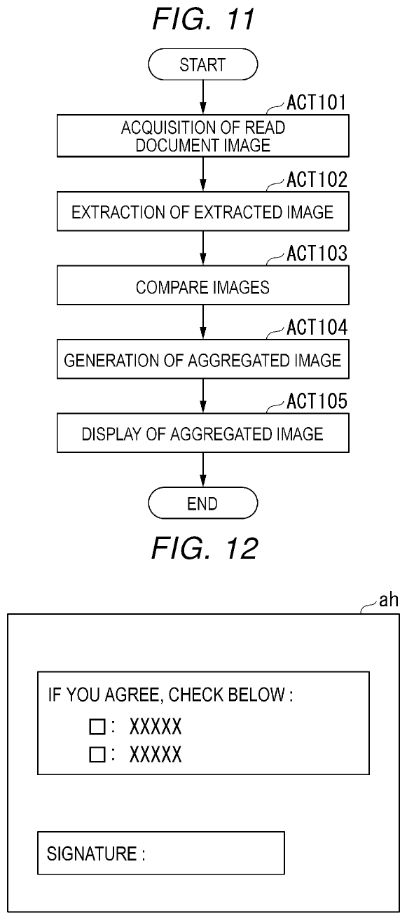

Subsequently, an example of the operation in case of acquiring the read document image of the image forming device 100 is described. FIG. 11 is a flowchart illustrating the operation in case of acquiring the read document image of the image forming device 100 according to the first embodiment. The operation of the image forming device 100 illustrated in the flowchart of FIG. 11 starts, for example, if the image data indicating the read document image is transmitted from the image reading unit 200 to the control unit 101.

First, the document image acquisition unit 1011 acquires the image data indicating the read document image. The document image acquisition unit 1011 stores the acquired image data indicating the read document image to the auxiliary storage device 103 as the read document image data 1034 (ACT 101).

Subsequently, the extracted image extraction unit 1014 acquires the read document image data 1034 and the extracted area setting information 1032 stored in the auxiliary storage device 103. The extracted image extraction unit 1014 extracts the image according to the coordinate indicated by the extracted area setting information 1032 from the read document image based on the read document image data 1034. Accordingly, the extracted image extraction unit 1014 extracts the image data indicating the extracted image. The extracted image extraction unit 1014 stores the extracted image data indicating the extracted image in the auxiliary storage device 103 as the extracted image data 1035 (ACT 102).

Subsequently, the image comparison unit 1015 acquires the reference image data 1033 and the extracted image data 1035 stored in the auxiliary storage device 103. The image comparison unit 1015 compares the reference image based on the reference image data 1033 with the extracted image based on the extracted image data 1035 for each extracted area. The image comparison unit 1015 determines whether the reference image and the extracted image are the same by comparing the luminance value of the reference image and the luminance value of the extracted image for each pixel at the same position. The image comparison unit 1015 stores the information indicating the comparison result for each extracted area in the auxiliary storage device 103 as the comparison result information 1036 (ACT 103).

Subsequently, the aggregated image generation unit 1016 acquires the extracted image data 1035 and the comparison result information 1036 from the auxiliary storage device 103. The aggregated image generation unit 1016 generates the image data indicating the aggregated image based on the acquired extracted image data 1035 and the acquired comparison result information 1036. At this point, the aggregated image generation unit 1016 generates the image data indicating the aggregated image, for example, in which the circumference of the extracted image determined to be the same as the reference image is surrounded by a thick frame (ACT 104).

Subsequently, the aggregated image generation unit 1016 promotes the corresponding aggregated image to the user by displaying the aggregated image based on the generate image data on the display 110 (ACT 105).

In the above, the operation in case of acquiring the read document image of the image forming device 100 illustrated in the flowchart of FIG. 11 ends.

As described above, the image forming device 100 according to the first embodiment extracts at least one extracted area from the read document image and generates the image data indicating the extracted image. The image forming device 100 compares the reference image and the extracted image for each extracted area and promotes the aggregated image obtained by aggregating the extracted image and the information indicating the comparison result to the user.

By providing such a configuration, the image forming device 100 according to the first embodiment can promote, to the user, the aggregated image in which only a predetermined entry field is aggregated and an unfilled entry field can be grasped at a glance. Accordingly, the image forming device 100 can more simplify the work of the user for confirming whether the information is entered in the predetermined entry field.

In addition, in the first embodiment described above, the aggregated image generation unit 1016 has a configuration of generating the image data indicating the aggregated image obtained by aggregating all extracted images extracted from one read document. Also, the aggregated image generation unit 1016 has a configuration of generating the image data indicating the aggregated image, for example, in which the circumference of the extracted image determined to be the same as the reference image is surrounded by the thick frame.

However, the embodiment is not limited to the above configuration, for example, the aggregated image generation unit 1016 has a configuration of generating the image data indicating the aggregated image obtained by aggregating a portion of the extracted images extracted from one read document. For example, the confirmation of the entry field is not required if any information is entered, and only the unfilled entry field is required to be quickly grasped. In this case, the aggregated image generation unit 1016 may have a configuration of generating the image data indicating the aggregated image obtained by aggregating only the extracted image determined to be the same as the reference image.

FIG. 12 is a diagram illustrating an example of the aggregated image. An aggregated image ah illustrated in FIG. 12 is an image obtained by aggregating the extracted image extracted from the read document sc illustrated in FIG. 8. For example, the aggregated image generation unit 1016 generates the image data indicating the aggregated image obtained by aggregating only the extracted image including the consent field and the signature field that are unfilled entry fields, as illustrated in FIG. 12.

### Second Embodiment

Hereinafter, an image forming device according to a second embodiment is described. The image forming device according to the second embodiment generates the image data indicating the image obtained by aggregating the extracted image extracted from one read document in the same manner as in the image forming device 100 according to the first embodiment. At this point, in the same manner as in the image forming device 100 according to the first embodiment, the image forming device according to the second embodiment generates the image data indicating the aggregated image in which the extracted image determined that the information is not entered in the entry field and the extracted image determined that the information is entered in the entry field can be distinguished.

By providing such a configuration, the image forming device according to the second embodiment can promote, to the user, the aggregated image in which only a predetermined entry field is aggregated, and the unfilled entry field can be grasped at a glance. Accordingly, the image forming device according to the second embodiment can more simplify the work of the user for confirming whether the information is entered in the predetermined entry field.

Further, the image forming device according to the second embodiment recognizes a character string entered in the entry field included in the extracted image and generates the image data indicating the aggregated image to which the recognized character string is added. By providing such a configuration, the image forming device according to the second embodiment can promote, to the user, the aggregated image in which the character string entered in the filled entry field can be grasped at a glance. Accordingly, the image forming device according to the second embodiment can simplify the work of the user for confirming the information entered in the entry field.

Hereinafter, the configuration of the image forming device according to the second embodiment is more specifically described. The overall configuration of the image forming device according to the second embodiment is the same as the overall configuration of the image forming device 100 according to the first embodiment illustrated in FIG. 1. The configuration of the image reading unit of the image forming device according to the second embodiment is the same as the configuration of the image reading unit 200 of the image forming device 100 according to the first embodiment illustrated in FIG. 2. The hardware configuration of the image forming device according to the second embodiment is the same as the hardware configuration of the image forming device 100 according to the first embodiment illustrated in FIG. 3.

Hereinafter, the configuration of a control unit 101-1 and the configuration of an auxiliary storage device 103-1 of the image forming device according to the second embodiment are described. Here, the difference from the first embodiment is mainly described, and the functional units with the same configurations as the image forming device 100 according to the first embodiment are denoted by the same reference numerals, and the description thereof is omitted.

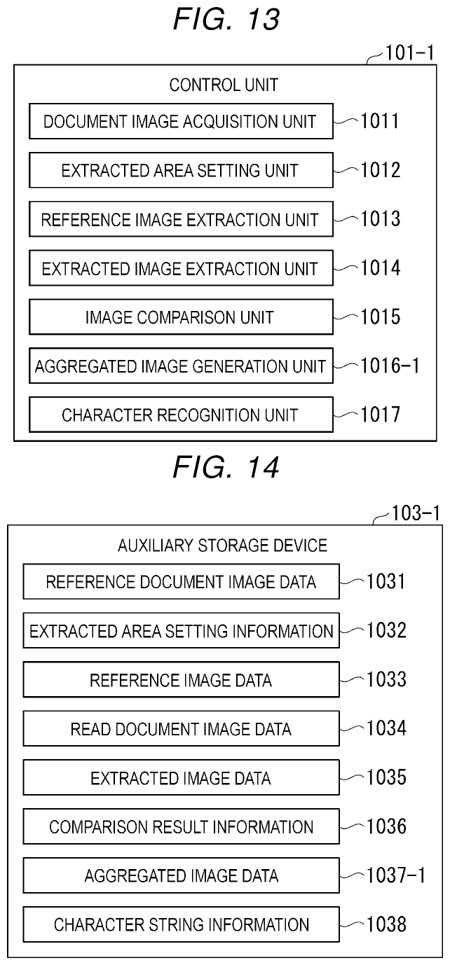

FIG. 13 is a block diagram illustrating a functional configuration of the control unit 101-1. As illustrated in FIG. 13, the control unit 101-1 includes the document image acquisition unit 1011, the extracted area setting unit 1012, the reference image extraction unit 1013, the extracted image extraction unit 1014, the image comparison unit 1015, an aggregated image generation unit 1016-1, and a character recognition unit 1017.

The difference of the control unit 101-1 from the control unit 101 of the image forming device 100 according to the first embodiment is that the control unit 101-1 includes the aggregated image generation unit 1016-1 instead of the aggregated image generation unit 1016, and the control unit 101-1 further includes the character recognition unit 1017.

FIG. 14 is a block diagram illustrating the configuration of the auxiliary storage device 103-1. As illustrated in FIG. 14, the auxiliary storage device 103-1 stores the reference document image data 1031, the extracted area setting information 1032, the reference image data 1033, the read document image data 1034, the extracted image data 1035, the comparison result information 1036, an aggregated image data 1037-1, and character information 1038.

The difference of the auxiliary storage device 103-1 from the auxiliary storage device 103 of the image forming device 100 according to the first embodiment is that the auxiliary storage device 103-1 stores the aggregated image data 1037-1 instead of the aggregated image data 1037, and the auxiliary storage device 103-1 further stores character string information 1038.

The character recognition unit 1017 acquires the comparison result information 1036 from the auxiliary storage device 103-1. The character recognition unit 1017 specifies the extracted image determined not to be the same as the reference image based on the acquired comparison result information 1036. The extracted image determined not to be the same as the reference image is an extracted image including an entry field that is assumed to be currently filled.

The character recognition unit 1017 recognizes the character string included in the extracted image determined not to be the same as the reference image. The character recognition unit 1017 recognizes a character, for example, by using optical character recognition (OCR). The character recognition unit 1017 stores information indicating the recognized character string in the auxiliary storage device 103-1 as the character string information 1038.

In the present embodiment, the character recognition unit 1017 has a configuration of recognizing a character in the extracted image, but the embodiment is not limited to this configuration. For example, the character recognition unit 1017 may recognize a character in a read document image at a timing when the document image acquisition unit 1011 acquires the image data indicating the read document image.

The aggregated image generation unit 1016-1 acquires the extracted image data 1035, the comparison result information 1036, and the character string information 1038 from the auxiliary storage device 103-1. The aggregated image generation unit 1016-1 generates the image data indicating the aggregated image based on the acquired extracted image data 1035, the acquired comparison result information 1036, and the acquired character string information 1038.

At this point, the aggregated image generation unit 1016-1 adds the information indicating the comparison result for each extracted area to the aggregated image data based on the comparison result information 1036. Specifically, the aggregated image generation unit 1016-1 generates the image data indicating the aggregated image, for example, in which the circumference of the extracted image determined to be the same as the reference image is surrounded by a thick frame.

Further, the aggregated image generation unit 1016-1 adds the information indicating the character string for each extracted area in which characters are recognized based on the character string information 1038 to the aggregated image data. Specifically, the aggregated image generation unit 1016-1 generates the image data indicating the aggregated image to which a character string image that is an image including the recognized character string is added, for example, under the extracted image in which the characters are recognized.

The aggregated image generation unit 1016-1 stores the generated image data indicating the aggregated image in the auxiliary storage device 103-1 as the aggregated image data 1037-1. In addition, the aggregated image generation unit 1016-1 may promote the corresponding aggregated image to the user by displaying the aggregated image on the display 110. Otherwise, the aggregated image generation unit 1016-1 promotes the corresponding aggregated image to the user, for example, by outputting the image data indicating the aggregated image to the printer unit 130 and forming the aggregated image on the sheet. Otherwise, the aggregated image generation unit 1016-1 may transmit, for example, the image data indicating the aggregated image to the PC of the user via the network interface 102.

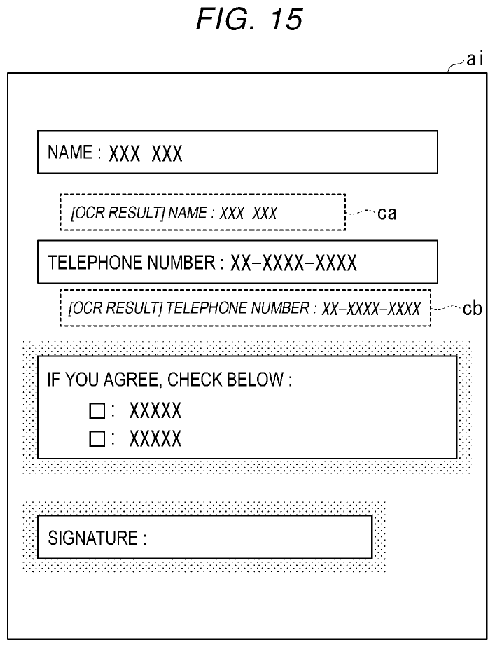

Hereinafter, the generation of the aggregated image by the image forming device according to the second embodiment is described with reference to the specific examples. FIG. 15 is a diagram illustrating an example of the aggregated image. An aggregated image ai illustrated in FIG. 15 is an image obtained by aggregating the extracted images extracted from the read document sc illustrated in FIG. 8. For example, as illustrated in FIG. 15, the aggregated image generation unit 1016-1 generates the image data indicating the aggregated image in which the circumferences of the extracted images including the consent field and the signature field that are the unfilled entry fields are surrounded by the thick frames.

Further, for example, as illustrated in FIG. 15, the aggregated image generation unit 1016-1 adds a character string image ca indicating a character string recognized from the corresponding extracted image under the extracted image including the entry field of the name that is the filled entry field. In addition, as illustrated in FIG. 15, for example, the aggregated image generation unit 1016-1 adds a character string image cb indicating the character string recognized from the corresponding extracted image under the extracted image including the entry field of the telephone number that is the filled entry field.

As described above, the image forming device according to the second embodiment further includes a character recognition unit that recognizes characters included in the extracted image. By providing such a configuration, the image forming device according to the second embodiment can promote, to the user, the aggregated image in which the entered character string can be grasped at a glance in the filled entry field. Accordingly, the image forming device according to the second embodiment can more simplify the work of the user for confirming whether the information is entered in the predetermined entry field.

In the second embodiment described above, the aggregated image generation unit 1016-1 has a configuration of adding the character string image including the recognized character string, for example, under the extracted image in which the characters are recognized. However, the embodiment is not limited to the above configuration, and for example, the aggregated image generation unit 1016 may have a configuration of adding the information indicating the recognized character string to the corresponding image file as metadata of the image file indicating the aggregated image. That is, the character string recognized by the OCR or the like may have a configuration of being added to an image file indicating the aggregated image in an invisible form.

In addition, for example, if a character entered in the entry field of the read document is unclear, it is considered that the character recognition is not correctly performed. In this case, the character recognition unit 1017 stores, for example, information indicating the character recognition is not correctly performed, in the auxiliary storage device 103-1 as the character string information 1038.

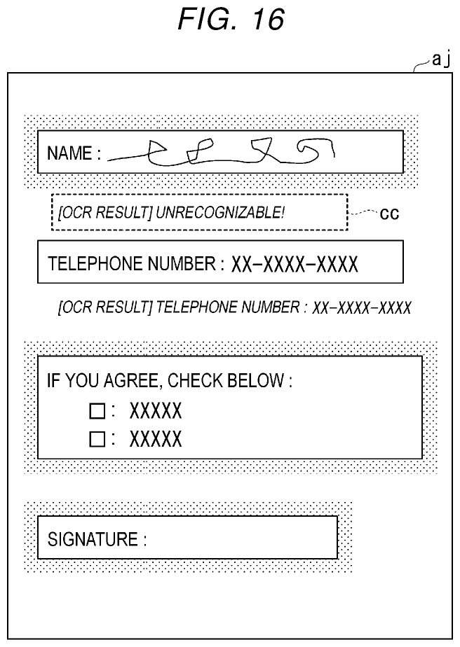

FIG. 16 is a diagram illustrating an example of the aggregated image. FIG. 16 illustrates the aggregated image if writing of which the character recognition is difficult is performed in the entry field of the name. In this case, the aggregated image generation unit 1016-1 generates the image data indicating the aggregated image to which the character string image indicating that the character recognition fails is added, under the extracted image. In the example of FIG. 16, the character string image indicating that the character recognition fails is a character string image cc including the writing “[OCR result] Unrecognizable!”

In addition, in this case, as illustrated in FIG. 16, the aggregated image generation unit 1016-1 may generate the image data indicating the aggregated image in which the circumference of the extracted image of which character recognition fails is surrounded by the thick frame in the same manner as in the extracted images determined to be the same as the reference images. In addition, as described above, the extracted image determined to be the same as the reference image is the extracted image including the unfilled entry field.

In addition, for example, it is considered that the content of the character string that is entered in the entry field of the read document is not the content to be written in the corresponding entry field. For example, a telephone number may be erroneously entered in the entry field of the name of the business form or the application form. Generally, in such a case, the character recognition itself is correctly performed by the character recognition unit 1017, and thus the user may easily overlook that the entered content has an error.

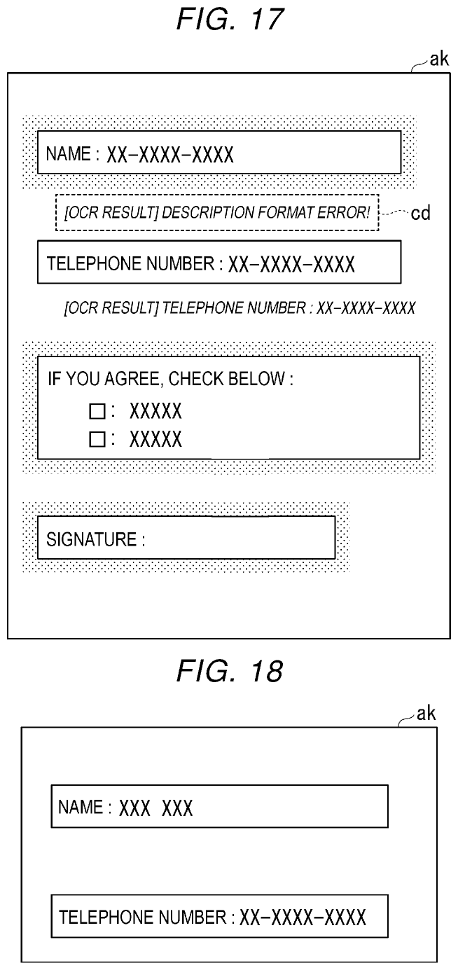

For such a case, for example, the character recognition unit 1017 may include a function of checking whether the description format of the recognized character string is a predetermined description format. FIG. 17 is a diagram illustrating an example of the aggregated image. FIG. 17 is an aggregated image if a telephone number is erroneously written in the entry field of the name.

In this case, the character recognition unit 1017 determine that the erroneous content is described based on the fact that an arithmetic number that is not originally entered is used in the entry field of the name. Also, the aggregated image generation unit 1016-1 generates the image data indicating the aggregated image to which the character string image indicating that the description format has an error is added under the extracted image. In the example of FIG. 17, the character string image indicating that the description format has an error is a character string image cd including the writing “[OCR result] the description format error!”

In addition, in this case, as illustrated in FIG. 17, the aggregated image generation unit 1016-1 may generate the image data indicating the aggregated image in which the circumference of the extracted image including the entry field that is determined that the erroneous content is described is surrounded by the thick frame in the same manner as in the extracted image determined to be the same as the reference image.

In addition, in the above embodiment, the configuration of the image forming device if the unfilled entry field is easily recognized by the user is mainly described, but the embodiment is not limited to this configuration. For example, a case where a business form, an application form, or the like that has an entry field that does not have to be filled is confirmed by the user may be considered. For example, there maybe a case where the user does not have to confirm the unfilled entry field and has to confirm only the filled entry field. In this case, for example, the aggregated image generation unit 1016 may generate the image data indicating the aggregated image obtained by aggregating only the filled entry fields.

FIG. 18 is a diagram illustrating an example of the aggregated image. An aggregated image ak illustrated in FIG. 18 is an image obtained by aggregating the extracted images extracted from the read document sc illustrated in FIG. 8. As illustrated in FIG. 18, for example, the aggregated image generation unit 1016 generates the image data indicating the aggregated image obtained by aggregating only the extracted image including the entry fields of the name and the telephone number that are the filled entry fields.

In addition, a method of comparing the reference image and the extracted image by the image comparison unit 1015 is not limited to a method of comparing a luminance value or a pixel value on a per pixel basis as described above. For example, the method may be a configuration of determining whether the reference image and the extracted image are the same by recognizing characters in both of the reference image and the extracted image by the character recognition unit 1017 and comparing the character string recognized from the reference image and the character string recognized from the extracted image by the image comparison unit 1015.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image reading device, comprising:
an image reading component configured to read an image on a document to generate read image data;
a controller configured to extract at least one predetermined area from the read image data to generate extracted image data, compare the extracted image data and reference image data determined for each of the predetermined area, and generate an aggregated image obtained by aggregating the extracted image data and information indicating a result of the comparison; and
an output component configured to output the aggregated image.

2. The image reading device according to claim 1,
wherein the controller generates the aggregated image in which a mark is added to an area determined that the extracted image data and the reference image data are the same by the comparison.

3. The image reading device according to claim 1,
wherein the controller generates the aggregated image obtained by aggregating the extracted image data and the information indicating the result of the comparison only for an area determined that the extracted image data and the reference image data are the same by the comparison.

4. The image reading device according to claim 1, further comprising:
a character recognition component configured to recognize a character included in the extracted image data,
wherein the controller generates the aggregated image to which the character recognized by the character recognition component is added to an area determined that the extracted image data and the reference image data are different from each other by the comparison.

5. The image reading device according to claim 1,
wherein the controller generates the aggregated image obtained by aggregating the extracted image data and the information indicating the result of the comparison with respect to only an area in which the extracted image data and the reference image data are different from each other by the comparison.

6. The image reading device according to claim 1,
wherein the controller generates the information indicating the result of the comparison for each of the predetermined areas based on a difference between a luminance value included in the extracted image data and a luminance value included in the reference image data.

7. The image reading device according to claim 1, further comprising:
a character recognition component configured to recognize a character included in the extracted image data and a character included in the reference image data,
wherein the controller generates the information indicating the result of the comparison for each of the predetermined areas based on a difference between a character recognized from the extracted image data and a character recognized from the reference image data.

8. The image reading device according to claim 1, further comprising:
a display component configured to display a reference document image formed in a document to be a reference, which is read by the image reading component; and
an input portion configured to receive an input operation of setting the predetermined area by designating any area of the reference document image displayed on the display component.

9. The image reading device according to claim 1,
wherein the controller specifies the predetermined area based on a position at which a predetermined anchor is recorded in a reference document image formed in a document to be a reference, which is read by the image reading component.

10. The image reading device according to claim 1, further comprising:
a character recognition component configured to recognize a character included in the extracted image data,
wherein the controller generates the aggregated image to which the character recognized by the character recognition component is added as additional information.

11. An image reading method, comprising:
reading an image on a document to generate read image data;
extracting at least one predetermined area from the read image data to generate extracted image data;
comparing the extracted image data and reference image data determined for each of the predetermined area;
generating an aggregated image obtained by aggregating the extracted image data and information indicating a result of the comparison; and
outputting the aggregated image.

12. The image reading method according to claim 11, further comprising:
generating the aggregated image in which a mark is added to an area determined that the extracted image data and the reference image data are the same by the comparison.

13. The image reading method according to claim 11, further comprising:
generating the aggregated image obtained by aggregating the extracted image data and the information indicating the result of the comparison only for an area determined that the extracted image data and the reference image data are the same by the comparison.

14. The image reading method according to claim 11, further comprising:
recognizing a character included in the extracted image data; and
generating the aggregated image to which the character recognized is added to an area determined that the extracted image data and the reference image data are different from each other by the comparison.

15. The image reading method according to claim 11, further comprising:
generating the aggregated image obtained by aggregating the extracted image data and the information indicating the result of the comparison with respect to only an area in which the extracted image data and the reference image data are different from each other by the comparison.

16. The image reading method according to claim 11, further comprising:
generating the information indicating the result of the comparison for each of the predetermined areas based on a difference between a luminance value included in the extracted image data and a luminance value included in the reference image data.

17. The image reading method according to claim 11, further comprising:
recognizing a character included in the extracted image data and a character included in the reference image data; and
generating the information indicating the result of the comparison for each of the predetermined areas based on a difference between a character recognized from the extracted image data and a character recognized from the reference image data.

18. The image reading method according to claim 11, further comprising:
displaying a reference document image formed in a document to be a reference, which is read by an image reading component; and
receiving an input operation of setting the predetermined area by designating any area of the reference document image displayed.

19. The image reading method according to claim 11, further comprising:
specifying the predetermined area based on a position at which a predetermined anchor is recorded in a reference document image formed in a document to be a reference, which is read.

20. The image reading method according to claim 11, further comprising:
recognizing a character included in the extracted image data; and
generating the aggregated image to which the character recognized is added as additional information.
